(19) United States
(12) Patent Application Publication
(10) Pub. No.: US 2014/0095062 A1
(43) Pub. Date: Apr. 3, 2014

(54) Road Maps from Clusters of Line Segments of Multiple Sources

(71) Applicant: HEWLETT-PACKARD DEVELOPMENT COMPANY, L.P., Fort Collins, CO (US)

(72) Inventors: Yin WANG, Palo Alto, CA (US); Xuemei LIU, Palo Alto, CA (US); Yanmin Zhu, Shanghai (CN)

(73) Assignee: HEWLETT-PACKARD DEVELOPMENT COMPANY, L.P., Fort Collins, CO (US)

(21) Appl. No.: 13/630,253

(22) Filed: Sep. 28, 2012

(51) Int. Cl. G01C 21/26; G06T 11/20

(52) U.S. Cl. 701/409; 345/442

(57) ABSTRACT

A method of generating a road map from clusters of line segments of multiple datapoint sources. The method includes defining line segments for the datapoint sources between consecutive samples from the sources, grouping the line segments into clusters according to a position criterion, applying curve fitting to the clusters to obtain centerlines, and generating a road map from the center lines.

### BACKGROUND

Accurate, current road maps are very important for route planning and safe vehicle navigation. Most existing road maps have been generated from geological surveys. This is an expensive and time-consuming process, and for these reasons such maps quickly become outdated, especially in fast-growing regions. Even in developed countries with relatively stable road networks, roads are often reconfigured or closed due to such factors as new construction, accidents, and maintenance. To generate maps at less cost and to timely update maps as new roads are built and conditions change, special survey vehicles have been equipped with specialized global positioning satellite (GPS) tracking devices that provide accurate position and velocity traces at frequent intervals, for example once per second. Data from these GPS devices are then used to generate road maps.

### BRIEF DESCRIPTION OF THE DRAWINGS

The figures are not drawn to scale. They illustrate the disclosure by examples.

FIG. 1 is a block diagram depicting an example of a method of generating a road map from clusters of line segments of multiple datapoint sources.

FIG. 2 is a block diagram depicting another example of a method of generating a road map from clusters of line segments of multiple datapoint sources.

FIG. 3 is a line diagram illustrating removal of line segments that violate a directional constraint in an example of generating a road map from clusters of line segments of multiple datapoint sources.

FIG. 4 is a line diagram illustrating the positional criterion of orientation of line segments in an example of generating a road map from clusters of line segments of multiple datapoint sources.

FIG. 5 is a line diagram illustrating construction of the backbone curve in an example of generating a road map from clusters of line segments of multiple datapoint sources.

FIG. 6 is a graphical depiction of the selection of control points for B-spline curve fitting in an example of generating a road map from clusters of line segments of multiple datapoint sources.

FIGS. 7A and 7B are a pictorial diagram of an example of a road map generation system including clustering of segments from multiple datapoint sources.

### DETAILED DESCRIPTION

Illustrative examples and details are used in the drawings and in this description, but other configurations may exist and may suggest themselves. Parameters such as voltages, temperatures, dimensions, and component values are approximate. Terms of orientation such as up, down, top, and bottom are used only for convenience to indicate spatial relationships of components with respect to each other, and except as otherwise indicated, orientation with respect to external axes is not critical. For clarity, some known methods and structures have not been described in detail. Methods defined by the claims may comprise steps in addition to those listed, and except as indicated in the claims themselves the steps may be performed in another order than that given.

The systems and methods described herein may be implemented in various forms of hardware, software, firmware, special purpose processors, or a combination thereof. At least a portion thereof may be implemented as an application comprising program instructions that are tangibly embodied on one or more program storage devices such as hard disks, magnetic floppy disks, RAM, ROM, and CDROM, and executable by any device or machine comprising suitable architecture. Some or all of the instructions may be remotely stored; in one example, execution of remotely-accessed instructions may be referred to as cloud computing. Some of the constituent system components and process steps may be implemented in software, and therefore the connections between system modules or the logic flow of method steps may differ depending on the manner in which they are programmed.

An ever-increasing number of vehicles such as taxis, buses, and other commercial vehicles are being equipped with dedicated GPS tracking devices and telephones. These GPS appliances periodically report their measurements, including position coordinates (in terms of latitude and longitude) and orientation (direction of travel). These measurements can be collected in real time through ubiquitous cellular wireless networks and potentially might be used to generate road maps. But their accuracy is not as good as that of the specialized equipment used by survey vehicles and they report less often, for example only once per minute. There is a need for a way to generate timely and accurate road maps using coarse GPS data from ordinary commercial vehicles without incurring the expense and inconvenience of mapping by means of specialized survey vehicles.

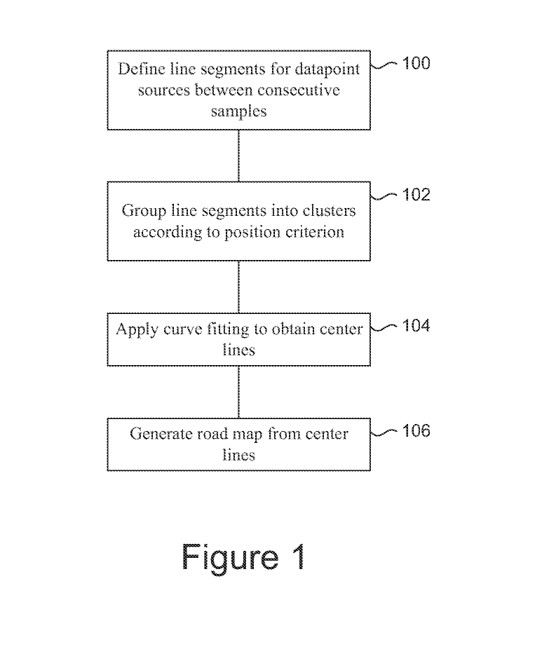

FIG. 1 gives an example of a method of generating a road map from clusters of line segments of multiple datapoint sources. Line segments for the datapoint sources are defined between consecutive samples from the datapoint sources (100). The line segments are grouped into clusters according to a position criterion (102). Curve fitting is applied to the clusters to obtain centerlines (104). A road map is generated from the center lines (106).

In some examples the samples may be indicative of positions and orientations of the datapoint sources. The directional constraint may comprise orientation of a line segment with respect to the orientations of the datapoints that define the segment.

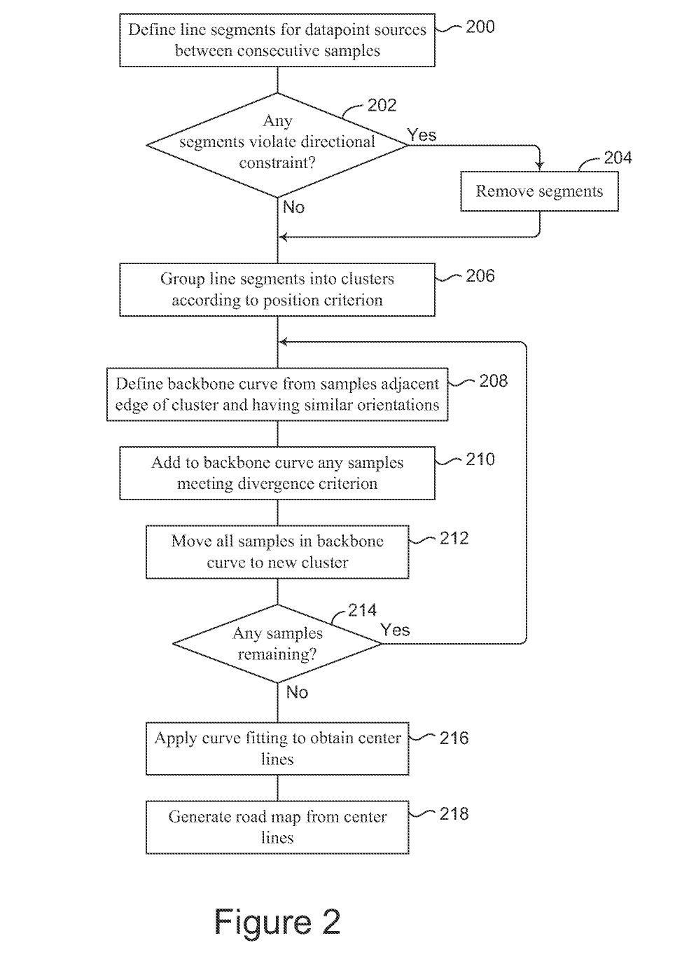

FIG. 2 gives an example of another method of generating a road map from clusters of line segments of multiple datapoint sources. Line segments for the datapoint sources are defined between consecutive samples from the datapoint sources (200). In some examples if any line segments violate a directional constraint (202), they are removed (204).

In some examples the samples may be indicative of positions and orientations of the datapoint sources. The directional constraint may comprise orientation of a line segment with respect to the orientations of the datapoints that define the segment. For example, the directional constraint may comprise a maximum angle between a line segment and a direction of travel of a datapoint that defines that segment. This is because a line segment is not useful in road recognition unless it approximates a drive path along the road.

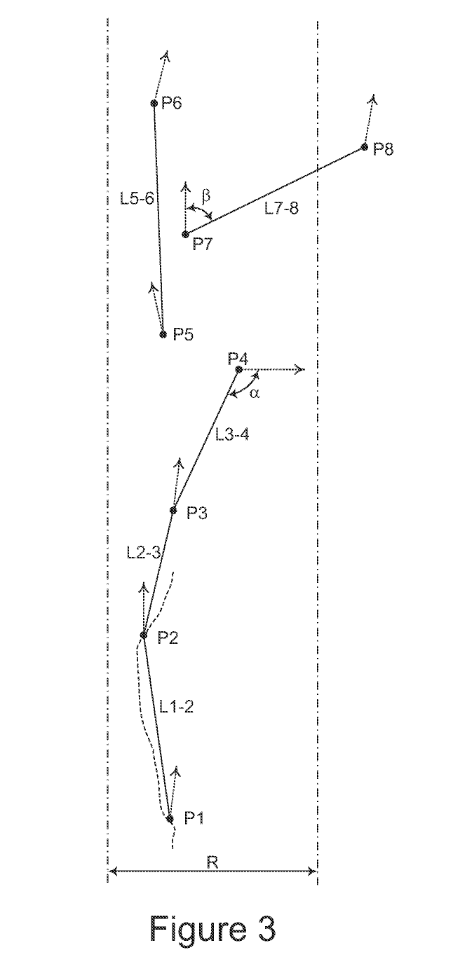

Referring to FIG. 3, consecutive datapoints P1, P2, P3, and P4 come from a vehicle traveling along a road R. Each datapoint includes latitudinal and longitudinal coordinates to indicate its position and directional information such as an angular displacement from north to indicate its orientation. Line segment L1-2 is defined between datapoints P1 and P2. The segment L1-2 is closely aligned with the orientations of the datapoints P1 and P2 and therefore should be retained. Similarly, segment L2-3 is defined between consecutive datapoints P2 and P3, and it also is in reasonably close alignment with the orientations of those datapoints and should be retained. The segment L3-4 is closely aligned with the orientation of datapoint P3 but not with that of datapoint P4. Instead, L3-4 makes a relatively large angle α with the orientation of the datapoint P4, suggesting that the datapoint source has turned across the road and is no longer giving a good indication of the road. Accordingly, L3-4 should be removed. Segment L5-6 is in good alignment with datapoints P5 and P6 that define it, and it should be retained. But segment L7-8 forms a large angle β with the orientation) of datapoint P7, suggesting that the datapoint source has turned off the road, and this line segment should be removed.

In one example an angle of 22.5° between a line segment and the orientation of the datapoints that define the segment was used as the maximum angle. Any line segments forming a larger angle with the orientation of one of their defining datapoints were removed.

Other criteria may be used in addition to or instead of the foregoing to determine whether a given line segment should be removed. For example, a line segment that gives obvious indications of error should be removed. If two consecutive datapoints define a line segment having a speed that is clearly incorrect, for example in excess of the maximum speed limit in the locality, that segment is suspect and should be removed. In one example a speed limit of 120 kilometers per hour (kph) was used.

The line segments can provide more information for recognizing roads than the raw datapoint samples. After removal of those line segments that are not likely to help define a road, layout of roads can be discerned by the distribution of the line segments despite errors that may remain. To recognize roads from error-prone samples, first the obviously-erroneous line segments are removed as described above and then various ones of the remaining line segments are recognized as belonging to one road based on similarity of the segments. Then curve fitting is used to compute the centerline of the road, and from the centerlines the road map can be generated.

To use curve fitting, the target curve to be fitted should comprise a function (specifically, a one-to-one mapping). The target curve represents such a function if there exists a transformation from the original coordinate system to a new coordinate system. The curve fitting can be performed in the new coordinate system, and then the resulting curve can be converted back into a curve in the original coordinate system. Accordingly, the line segments should be clustered in such a way that the target curve represents a function. Also, the number of clusters should be minimal so that the number of resulting fitted curves is also minimal. This helps to make the computed roads smoother and closer to the actual physical road layout.

Returning to FIG. 2, the line segments are grouped into clusters according to a position criterion (206).

In some examples the position criterion comprises two metrics—orientation and distance. If two line segments are close to each other and share a similar orientation, they are likely from the same road, and the two segments should be grouped into a single cluster.

The orientation metric may be thought of as a separation angle θ between two line segments L₁ and L₂. This angle may be computed by:

$$θ ( {L}_{1} , {L}_{2} ) {=}^{Δ} a cos \frac{\vert \vec{{f}_{i + 1} - {f}_{i}} \cdot \vec{{f}_{j + 1} - {f}_{j}} \vert}{d ( {L}_{1} ) d ( {L}_{2} )}$$

where fᵢ and fᵢ₊₁ are the i-th and (i+1)-th datapoints that define the segment L₁, fⱼ and fⱼ₊₁ are the j-th and (j+1)-th datapoints that define the segment L₂, and d(L₁) and d(L₂) are the lengths of the segments L₁ and L₂.

The distance metric is the shortest distance δ between the line segments L₁ and L₂. This distance may be determined from the datapoints that define the segments because the positions of the datapoints are expressed in latitude and longitude, and separation distance may be computed from these.

In some examples, two clusters are grouped into one cluster if one of them contains at least one line segment L₁ and the other contains at least one line segment L₂ such that θ(L₁, L₂)≦θₘₐₓ and δ(L₁, L₂)≦δₘₐₓ.

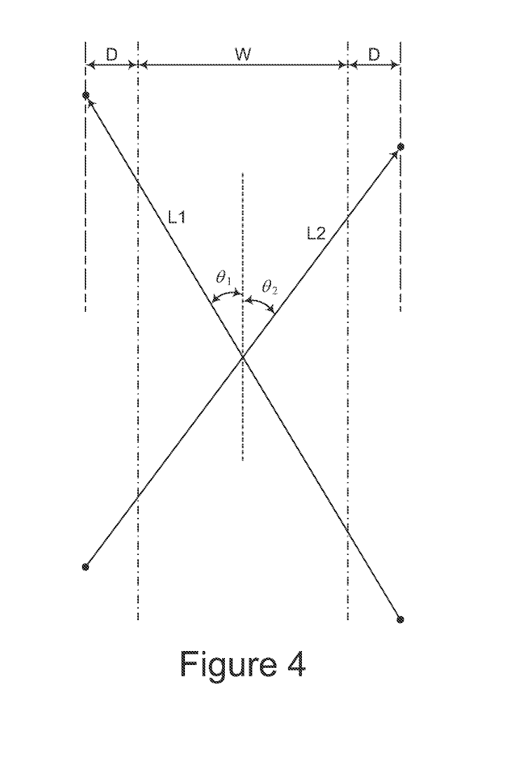

The maximum angle θₘₐₓ should be defined as the maximum that may occur between two segments that belong to the same road. The worst case occurs when two endpoints of each segment are separated by the road and cross each other, as illustrated in FIG. 4. The angle θ(L₁, L₂) between the segments L₁ and L₂ is just θ(L₁, L₂)=θ₁+θ₂ and if this angle does not exceed θₘₐₓ then the criterion is met. For a given road, θₘₐₓ may be determined by

$${θ}_{max} = arcsin \frac{D + \frac{W}{2}}{\frac{d ( {L}_{1} )}{2}} + arcsin \frac{D + \frac{W}{2}}{\frac{d ( {L}_{2} )}{2}}$$

where W is the width of the road and D is the position resolution of the sensors. In one example using GPS receivers, the receivers provided latitude and longitude to within ±0.0001, which in that location computed to 8.5 meters of latitude and 11.1 meters of longitude, providing a position resolution

$$D = \sqrt{{( \frac{8.5}{2} )}^{2} + {( \frac{11.1}{2} )}^{2}} \approx 7 meters .$$

If the line segments are too short, which may happen for example at an intersection where traffic is moving slowly and turning, the above procedure for finding θₘₐₓ will not provide a useful result. In this situation, an overall maximum may be established. In one example a maximum of 15° was used.

From FIG. 4 it will be seen that the maximum distance δₘₐₓ between the line segments is given by δₘₐₓ=2D+W. If, as will often be the case, the widths of the roads are not known in advance, a representative width may be used. In one example this representative width was set to 30 meters.

If a cluster includes divergent line segments that represent two different roads crossing at an oblique angle (212), for example a Y-type intersection, these divergent line segments may be placed in separate clusters so that each cluster will represent only one road. This involves defining a backbone curve from samples adjacent an edge of the cluster and having similar orientations (208) and then adding to this backbone curve any datapoint samples meeting a divergence criterion (210).

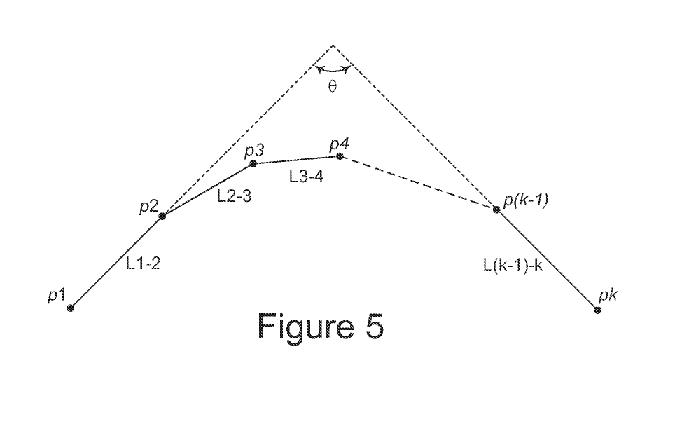

A backbone curve is defined by constructing a polyline. An example of polyline is shown in FIG. 5: a plurality of line segments L1-2, L2-3, . . . , L(κ−1)−κ are defined between datapoints p₁, p₂, . . . p_{κ}, forming a polyline. To define a backbone curve for a given cluster A, the datapoints in A are scanned to find the westernmost datapoint (if A spans wider in latitude) or the southernmost (if A spans wider in longitude). The selected datapoint is treated as the starting point of the polyline. Then the polyline is incrementally extended by searching for new datapoints. If, as shown in FIG. 5, a polyline ends with a datapoint p_{κ}, a next datapoint f is selected to serve as a new datapoint p_{κ} such that

d(f,p_{κ})≧dₛₜₑₚ

and

θ(\vec{p_{κ-1}−p_{κ}},\vec{p_{κ-1}−f})<ε

where dₛₜₑₚ is a constant. In some examples dₛₜₑₚ may be between one and ten meters. In other examples it may be as much as 100 meters. ε is a constant which in some examples is 15°.

The polyline is complete when no more datapoints can be found to extend it. Then other datapoints close to this polyline are grouped with it and removed from the cluster A into a new cluster A₁ (212). A given datapoint fᵢ is moved into the new cluster if:

$${min}_{j ∈ [ 1 , K - 1 ]} d ( {f}_{i} , L ( {p}_{j} , {p}_{j + 1} ) ) < 2 D + W$$

This process continues (214) until the cluster A is empty.

When the above process is complete, each cluster defines one road. In some examples the foregoing procedure is used on all clusters, but only those clusters that actually contain trajectories corresponding with two or more roads will be split into separate clusters.

Curve fitting is applied to find the centerlines of the roads (216) and a road map is generated from the centerlines (218). There are several different ways to fit curves, and inasmuch as roads can come in many different shapes, a curve fitting that is suitable for varieties of shapes is used. Good results have been obtained from uniform cubic B-spline fitting, which treats the target curve as a smooth piecewise-polynomial function.

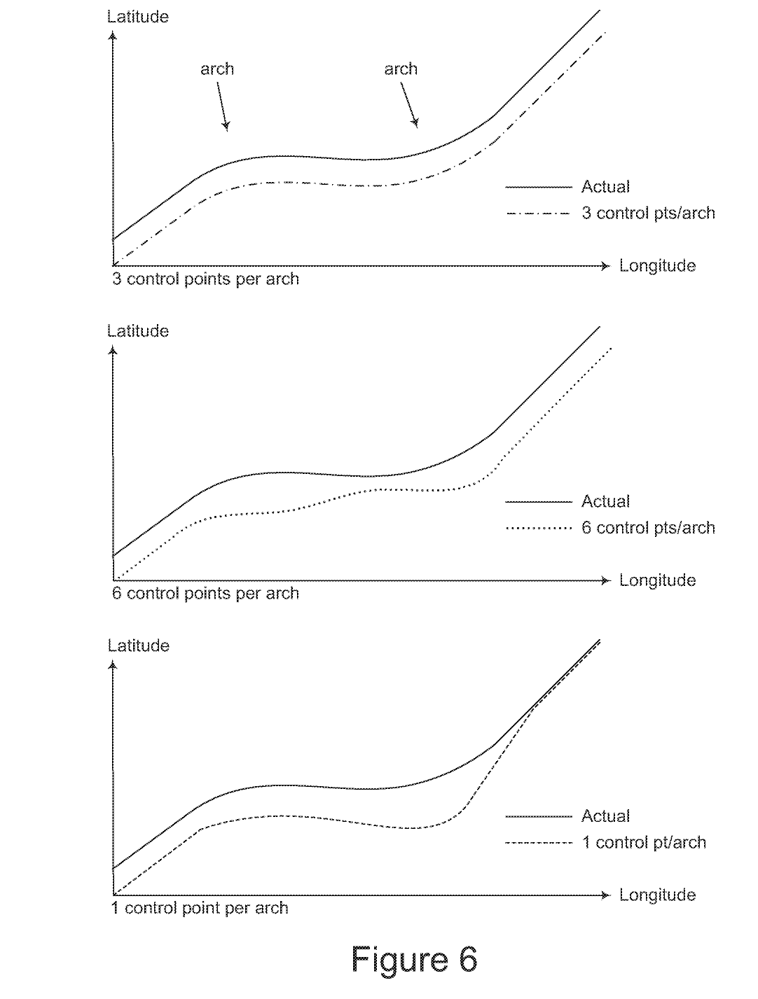

As shown in FIG. 6, the number of control points used in applying B-spline fitting to a cluster influences the shape of the fitted B-spline. To obtain a good fit, the number of control points should be set according to the shape of the underlying road segment rather than the number of sample points. Too small or too large a number of control points may lead to poor fitting. The top graph shows an actual road curve (solid line) having two arches (changes of direction) marked by arrows, and a curve obtained from clusters of trajectories of multiple datapoint sources as described in the foregoing examples and using three control points per arch. The two curves are offset in latitude for ease of viewing. The middle graph shows the same actual road curve compared with a curve obtained from clusters of trajectories of multiple datapoint sources and using six control points per arch. The disparities between the two curves are not great, and while this curve would be usable in generating a road map, the comparison shows that over-fitting can result in a curve that does not fit quite as well as one that is optimally fit. Similarly, the lower graph shows the same actual road curve compared with a curve obtained from clusters of trajectories of multiple datapoint sources and using only one control point per arch, again showing a curve that is adequate but not quite as good.

Based on the foregoing, shape-aware curve fitting with the number of control points set at three per arch results in a close match between an actual road and a road as determined from clusters of line segments.

Of course, in preparing an actual road map from clusters of line segments, the actual shape of the roads is not known in advance and therefore the number of arches (changes of direction) is also not known. A cluster should include a sufficient number of samples (datapoints) to support inference of a road; in other words, the cluster must have at least enough samples to provide minimum support for inferring a road. A cluster may be divided into sections of length L, each of which must also have a minimum supporting number of samples, and then the center points of these sections may be linked to determine how many arches there are in the cluster. The number of arches is multiplied by three, or another multiplier if desired, to determine the number of control points to use for the cluster.

The appendix gives pseudo-code for determining the number of arches in a cluster by finding and counting the places where the curve changes direction. Inputs include, in addition to the set of samples in a cluster S, a specified minimum support number M of samples in S below which the number of arches cannot feasibly be determined, a length L of a span of one section of S, and a minimum number T of samples in one span. In one example good results were obtained with M=T=5 and L=200 meters.

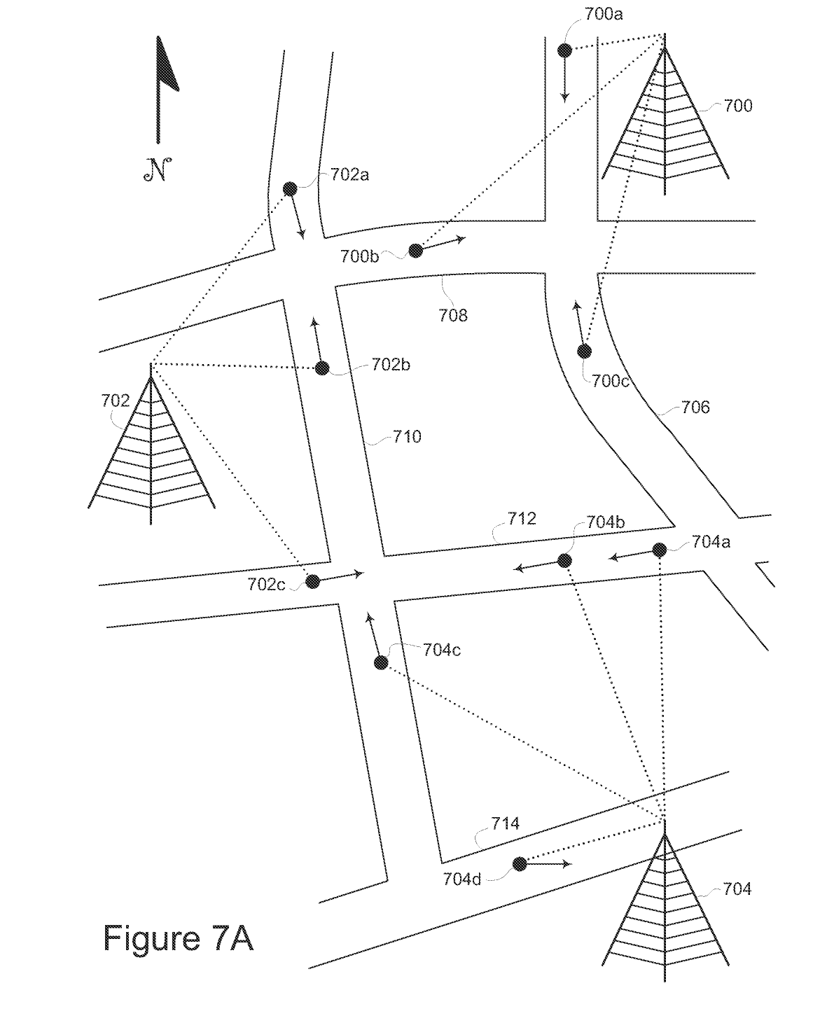

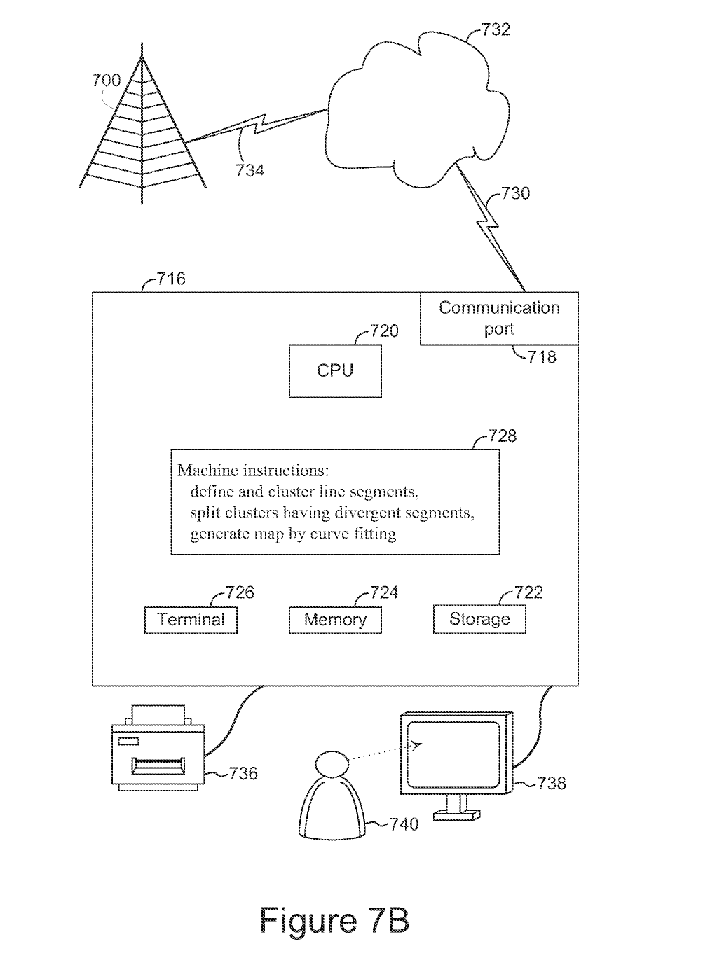

FIGS. 7A and 7B give en example of a road map generation system including clustering of segments from multiple datapoint sources. The system includes a plurality of sensors to provide datapoints indicative of positions and orientations of the datapoint sources, a receiver in communication with the sensors, a map display device, and a server in communication with the receiver and the map display device.

In this example the receiver includes a plurality of towers 700, 702, and 704 located in various places through a region having roads that are to be mapped. The Lower 700 is in communication with sensors 700a. 700b, and 700c; the tower 702 is in communication with sensors 702a, 702b, and 702c; and tower 704 is in communication with sensors 704a, 704b, 704c, and 704d.

The sensors may be carried by motor vehicles, including commercial vehicles such as taxi cabs, buses, and the like. In the illustrated example, the sensors 700a, 700b, and 700c are moving in a southerly direction along a road 706, an easterly direction along a road 708, and a northerly direction along the road 706, respectively. Similarly the sensors 702a, 702b, and 702c are moving in a southerly direction along a road 710, a northerly direction along the road 710, and an easterly direction along the road 712, respectively. The sensors 704a and 704b are moving in a westerly direction along the road 712, the sensor 704c is moving in a northerly direction along the road 710, and the sensor 704d is moving in an easterly direction along a road 714.

As the sensors move about, they may cease to communicate with one tower and instead communicate with another. There may be times when various ones of the sensors are not in communication at all, for example if they move out of range of the towers. The receiver is shown in this example as comprising three towers. These towers may comprise stand-alone receivers or remote antennas for one receiver. They may be interconnected either wirelessly or by land lines. In some examples the receiver comprises a cell phone network (towers and other devices) that serves other functions as well as gathering data from sensors for generating roads.

A server 716 is in communication with the receiver, for example through a communication port 718. The server includes a central processing unit (CPU) 720 and may also include one or more of storage 722 such as a hard disk, memory 724, and a user terminal 726 (keyboard, display, etc.). The server may include machine instructions 728. These instructions may be stored in the memory 724 or in the storage 722, or they may be hardwired into the CPU, or they may be stored remotely and sent to the server through the communication port 718 as needed.

The server communicates with the outside world through the communication port 718. This port is shown as communicating through a communication link 730, which may comprise one or more of a hard-wired connection, a wireless connection, or any other method of receiving and transmitting data. In some examples the server connects through a network 732 that may be referred to as “the cloud”. In this example the receiver is shown as communicating with the server 716 through a communication link 734 between the tower 700 and the network 732, but in other examples the communications may be configured in other ways.

A map display device provides a map that is generated by the system. The map display device may comprise a printer 736 that provides hard copies of road maps generated by the system, or a visual display 738 that displays a road map to a user 740, or another suitable device for providing hard copy maps, or visually-displayed maps, or transmitting a digital map image to another location.

The system includes instructions such as the machine instructions 728 to define line segments between the datapoints, group any line segments that are close to each other into a cluster, and generate a road map on the map display device by curve fitting the clusters.

in some examples grouping any line segments that are close to each other into a cluster comprises grouping into a cluster any line segments that are closer together than a predetermined distance and that have orientations that differ by less than a predetermined separation angle, as described previously. Some examples also include splitting a cluster that contains line segments indicative of divergent road centerlines into two or more clusters each containing line segments indicative of only one road centerline.

A data set collected by taxi cabs in Shanghai, China was used to generate a road map for that city using the foregoing principles. The data were collected by the Shanghai Transport Authority from some 2,300 taxis over a one-week period from 18 to 24 Feb. 2007. It was found that using data collected from these taxis during a 1.5 hour time period resulted in 93% coverage of arterial roads and a false positive rate of 5%. A road map produced from this data was found to be more accurate than a commonly-used map provided through OpenStreetMap (OSM), as described in M. M. Haklay and P. Weber, “OpenStreetMap: user-generated street maps”, IEEE Pervasive Computing 7:12-18, 2008, and based on both GPS traces and satellite imagery.

The taxi data from Shanghai actually included many more than 2,300 taxis, but at any given time not all of them were active. Reporting intervals varied from 16 to 61 seconds. Only eight cardinal directions were included, giving an orientation resolution of 22.5°. The city includes over 14,000 road segments (a road segment is a length of road between intersections) of which about 84% are shorter than one kilometer.

About one-third of the segments have curvature of less than 1°. The others have more curvature, and some 20% of the segments are curved 45° or more with some exceeding 90°. Referring to FIG. 5, the curvature of a road expressed as an angle θ is defined as the amount a vehicle has to turn when driving through the segment.

A comparison was performed between generating a road map by a simple cluster-and-fit (SCF) procedure and by the clustering and adaptive fitting (CAF) principles set forth above. Just to find arterial roads, CAF was able to accurately plot 93% of arterial roads using data from 2,000 taxis over 1.5 hours, whereas SCF required samples collected over more hours, and even with six hours of data it still did not match CAF. SCF produced false positives of nearly 20% even with six hours of data, whereas CAF produced less than 5% false positives with only one hour of data. CAF achieved separation distances of less than 40 meters with only one hour data, whereas SCF at first returned separation distances of nearly 60 meters and never got better results than about 47 meters.

Coverage differs for different kinds of roads. Coverage for arterial roads (the most heavily-traveled roads) reached 93% with only 1.5 hours of data but did not significantly change with more data, apparently because the taxis never visited the remaining arterial roads. Coverage of secondary roads was about 60%. Coverage of branch roads was slightly over 40% with only a small number of samples. Comparison with Open Street Map shows that the CAF road map was more accurate.

Generating road maps according to the principles described herein results in road maps with wide coverage, a low rate of false positives, and significantly better accuracy than can be obtained from other methods. The only required input data is readily-available GPS traces respecting movements of commercial vehicles.

```
APPENDIX
Inputs:
      S = a cluster (set of all the samples in the cluster)
      M = minimum support (number of samples in S)
      L = length of span of one section of S
      T = minimum support (number of samples in one section)
Output:
      ω = number of arches in cluster S
Procedure
      if |S| < M
          return 0; //No fitted road will be produced
      end if
      if samples in S span wider in latitude
          μ₀ = westernmost sample;
      else
          μ₀ = southernmost sample;
      end if
      S₁ = {closest T samples in S to μ₀};
      S₁ = S₁ ∪ {p|p ε S, d(p, μ₀) ≦ L};
      μ₁ = center point of all samples in S₁;
      S = S − S₁;
      k = 1;
      while S ≠ NULL
          k++;
          Sₖ = {closest T samples in S to μₖ₋₁ };
          Sₖ = Sₖ ∪ {p|p ε S, d(p, μₖ₋₁) ≦ 3/2 L};
          μₖ = center point of all samples in Sₖ;
          S = S − Sₖ;
      end while
      Generate vectors \vec{v}ₗ = μᵢ₊₁ − μᵢ, i ε [1, k − 1];
      ω = 1;
      for i = 2:k − 2
          if (\vec{vₗ − 1} × \vec{vₗ}) · (\vec{vₗ} × \vec{vₗ₊₁}) > 0
              ω++; //new arch appears
          end if
      end for
      return ω;
end
```

What is claimed is:

1. A method of generating a road map from clusters of line segments of multiple datapoint sources, the method comprising:
defining line segments for the datapoint sources between consecutive samples from the sources;
grouping the line segments into clusters according to a position criterion;
applying curve fitting to the clusters to obtain centerlines; and
generating a road map from the centerlines.

2. The method of claim 1 and further comprising removing any line segments that violate a directional constraint.

3. The method of claim 2 wherein the directional constraint comprises a maximum angle between a line segment and an orientation of a datapoint that defines that line segment.

4. The method of claim 1 wherein the position criterion comprises one or more of a maximum separation angle between line segments and a maximum distance between line segments.

5. The method of claim 1 wherein grouping the line segments comprises splitting a cluster that contains line segments indicative of divergent road centerlines by:
defining a backbone curve from a plurality of samples adjacent an edge of a cluster, the samples having similar orientations;
adding to the backbone curve any other samples that satisfy a divergence criterion with respect to the samples in the backbone curve;
moving all the samples in the backbone curve to a new cluster; and
repeating until all samples have been added to a backbone curve.

6. The method of claim 5 wherein the divergence criterion comprises a distance between samples and a difference of orientation between samples.

7. The method of claim 1 wherein curve fitting comprises shape-aware curve fitting according to how many direction changes are in a cluster.

8. The method of claim 1 wherein curve fitting comprises B-spline curve fitting.

9. The method of claim 8 wherein curve fitting comprises determining how many direction changes are in a cluster and identifying a quantity of control points for curve fitting that cluster according to the number of direction changes.

10. A road map generation system including clustering of segments from multiple datapoint sources, the system comprising:
a plurality of sensors to provide datapoints indicative of positions and orientations of the datapoint sources;
a receiver in communication with the sensors;
a map display device; and
a server in communication with the receiver and the map display device to define line segments between the datapoints, group any line segments that are close to each other into a cluster, and generate a road map on the map display device by curve fitting the clusters.

11. The system of claim 10 wherein the datapoint sources comprise motor vehicles.

12. The system of claim 10 wherein the sensors comprise GPS units and the receiver comprises a cell phone network.

13. The system of claim 10 wherein the map display device comprises a printer.

14. The system of claim 10 wherein grouping any line segments that are close to each other into a cluster comprises grouping into a cluster any line segments that are closer together than a predetermined distance and that have orientations that differ by less than a predetermined separation angle.

15. The system of claim 14 and further comprising splitting a cluster that contains line segments indicative of divergent road centerlines into two or more clusters each containing line segments indicative of only one road centerline.
